(19) United States
(12) Patent Application Publication
(10) Pub. No.: US 2014/0020821 A1
(43) Pub. Date: Jan. 23, 2014

(54) Method and Device for Imparting an Image onto a Surface via Condensation

(71) Applicant: Donald J. Wagner, II, Pittsburgh, PA (US)

(72) Inventor: Donald J. Wagner, II, Pittsburgh, PA (US)

(21) Appl. No.: 13/946,269

(22) Filed: Jul. 19, 2013

Related U.S. Application Data
(60) Provisional application No. 61/673,281, filed on Jul. 19, 2012.

(51) Int. Cl. B44C 1/175; C09D 5/00

(52) U.S. Cl. CPC B44C 1/175; C09D 5/00
USPC 156/247; 428/195.1; 428/202

(57) ABSTRACT

The present invention is directed to method and device for modifying how water interacts with a surface to produce an image on said surface when water condensates on the surface. The present invention is also directed to articles for imparting an image onto a surface via condensation. An object of the present invention is to provide a method of modifying a surface or substrate such that an image is formed when water condensation droplets covers the surface or substrate. This is achieved by modifying a surface or substrate to make it have a different surface energy and therefore a different hydrophobicity or hydrophilicity than the base substrate or surface. The present invention provides a method of creating a coating on a surface to control the interaction of water with a coated surface.

### CROSS REFERENCE TO RELATED APPLICATION

This application is related to and claims the benefit of U.S. Provisional Patent Application 61/673,281 filed on Jul. 19, 2012, which is herein incorporated by reference in its entirety.

### BACKGROUND OF THE INVENTION

Hydrophobic and hydrophilic describes the way water interacts with a surface. Hydrophobic surfaces tend not to adsorb water or be wetted by water. Hydrophilic surfaces tend to adsorb water or be wetted by water. The interaction of the boundary of a solid with liquid or vapor water is what the terms hydrophobic and hydrophilic are used for. Surfaces can be modified to control the interaction with water, affecting the way that water wets a surface. The polar nature of water, with its positive oxygen and negative hydrogen dipole, accounts for its attraction to hydrophilic surfaces, and its lack of attraction to hydrophobic surfaces. Water droplets on a hydrophilic surface will have a low contact angle and a high contact angle on a hydrophobic surface. These tiny droplets act like a micro lens array. The greater the contact angle of the droplets, the more light is scattered by said droplet. The more light that is scattered, the more the surface appears to have a “foggy” or “frosted” appearance and is brighter in luminance. This will be referred to as a fogged surface. When less light is scattered by droplets with a low contact angle on a hydrophilic surface, the more the surface looks darker in luminance and appearance as compared to the fogged surface. This will be referred to as a wetted surface. Altering portions of a surface to control the presence of the fogged or wetted regions of a surface allows the creation of an image when the water droplets are present from condensation.

### SUMMARY OF THE INVENTION

The present invention is directed to a method and device for modifying how water interacts with a surface to produce an image on said surface when water condensates on the surface. The present invention is also directed to articles for imparting an image onto a surface via condensation.

An object of the present invention is to provide a method of modifying a surface or substrate such that an image is formed when water condensation droplets cover the surface or substrate. This is achieved by modifying a surface or substrate to make it have a different surface energy and, therefore, a different hydrophobicity or hydrophilicity than the base substrate or surface. The present invention provides a method of creating a coating on a surface to control the interaction of water with a coated surface. The present invention also provides a device for applying creating a coating on a surface to control the interaction of water with a coated surface.

Examples of substrates to be modified by application of the present invention include but are not limited to glossy surfaces such as glass, plastics, ceramic, composites, metals, stone, natural materials and the like.

Examples of surface modifiers that could be used to modify a substrate include but are not limited to silane, siloxanes, silicones, polymeric coatings, petroleum based oils, petroleum based waxes, plant based oils, plant based waxes, animal based oils, animal based waxes, beeswax, hydrogels, water based coatings, solvent based coatings or the like.

The surface modifiers need to be delivered or applied to the substrate in order to affect the substrate. The delivery method could include a transfer film by which a coating or surface treatment in the form of an image can be transferred to a surface such that the image becomes most apparent to the naked eye when water condensation covers the surface, a method for producing the same. The image which is transferred to a surface can either be temporary or permanent depending on the particular chemical composition utilized on the transfer film.

The surface modifiers can be delivered by a number of different methods either to simply apply a coating of surface modifying composition or to apply a surface modifying composition in a pattern, image, indicia, or the like. For example, the surface modifying composition could be applied to a substrate or transfer film using letterpress methods, stamping methods, offset lithography methods, flexography methods, gravure methods, screen printing methods, plotter printer methods, methods using a computer controlled two-axis plotter printer, methods using a paint pen, spray painting methods, stenciling methods, freehand, digital printing methods, inkjet printing methods, laser printing, toner printing; magnetic digital printing or the like.

Any suitable organic or inorganic material could be used as a transfer film material including but not limited to polymer based materials, plastic based materials, paper based materials, composite materials or the like.

Specifically, it is an object of the present invention to provide a transfer film device for applying a surface modifying composition in a pattern, image, or the like. It is also an object of the present invention to provide a method of creating such a transfer film device. It is another object of the present invention to provide a method of using a transfer film device for applying a surface modifying composition in a pattern, image, or the like.

Another object of the present invention is to provide advertising or greeting card space on transparent materials and surfaces, by selectively modifying the surface properties of a substrate. However, persons skilled in the art will recognize additional uses and advantages of the present invention.

In an embodiment the invention is a device for imparting an image onto a surface via condensation comprising, a first film sheet with a surface modifying composition disposed on said first film sheet, wherein said surface modifying composition is substantially transparent. In another embodiment the device further comprises a second film sheet in contact with said surface modifying composition protecting the surface modifying composition and holding said surface modifying composition in place. In another embodiment the device further comprises an adhesive layer between said first film sheet and said surface modifying composition. In another embodiment the device further comprises a second film sheet in contact with said surface modifying composition protecting the surface modifying composition and holding said surface modifying composition in place, and further comprises an adhesive layer between said first film sheet and said surface modifying composition. In another embodiment said surface modifying composition is disposed on said first film sheet so as to form at least one of a pattern, an image, and an indicia. In another embodiment said surface modifying composition comprises at least one of a silane, a siloxane, a silicone, a polymeric coating, a petroleum based oil, a petroleum based wax, a plant based oil, a plant based wax, an animal based oil, an animal based wax, a beeswax, a hydrogel, a water based coating, and a solvent based coating. In another embodiment said surface modifying composition comprises at least one of a silane, and a siloxane, capable of permanently modifying a surface. In another embodiment said surface modifying composition comprises at least one of a silicone, a polymeric coating, a petroleum based oil, a petroleum based wax, a plant based oil, a plant based wax, an animal based oil, an animal based wax, a beeswax, a hydrogel, a water based coating, and a solvent based coating, capable of temporarily modifying a surface.

In another embodiment the invention is a method of imparting an image onto a surface via condensation comprising the steps of, providing a first film sheet with a surface modifying composition disposed on said first film sheet, wherein said surface modifying composition is substantially transparent; placing the first film sheet onto a substrate with said surface modifying composition being in contact with said substrate, and removing the first film sheet from the substrate so that at least a portion of the surface modifying composition remains in contact with the substrate. In another embodiment the method further comprises the step of applying pressure to the first film sheet on the substrate to apply the surface modifying composition to the substrate. In another embodiment the method further comprises the step of positioning an adhesive layer between said first film sheet and said surface modifying composition. In another embodiment the method further comprises the steps of positioning a second film sheet in contact with said surface modifying composition for protecting the surface modifying composition and holding said surface modifying composition in place, and removing said second film sheet from contact with said surface modifying composition. In another embodiment the method further comprises the steps of positioning an adhesive layer between said first film sheet and said surface modifying composition, positioning a second film sheet in contact with said surface modifying composition protecting the surface modifying composition and holding said surface modifying composition in place, and removing said second film sheet from contact with said surface modifying composition. In another embodiment said surface modifying composition is disposed on said first film sheet so as to form at least one of a pattern, an image, and an indicia. In another embodiment said surface modifying composition comprises at least one of a silane, a siloxane, a silicone, a polymeric coating, a petroleum based oil, a petroleum based wax, a plant based oil, a plant based wax, an animal based oil, an animal based wax, a beeswax, a hydrogel, a water based coating, and a solvent based coating. In another embodiment said surface modifying composition comprises at least one of a silane, and a siloxane, permanently modifying a surface of the substrate. In another embodiment said surface modifying composition comprises at least one of a silicone, a polymeric coating, a petroleum based oil, a petroleum based wax, a plant based oil, a plant based wax, an animal based oil, an animal based wax, a beeswax, a hydrogel, a water based coating, and a solvent based coating, temporarily modifying a surface of the substrate. In another embodiment the substrate is constructed of at least one of a glass, a plastic, a ceramic, a metal, and a stone. In another embodiment the substrate is a glass. In another embodiment the substrate is a plastic.

### BRIEF DESCRIPTION OF THE DRAWINGS

FIG. 1 shows a cross-sectional diagram of a laminate transfer film of an embodiment of the present invention;

FIG. 2 shows a diagram of the steps for using the laminate transfer film in an embodiment of the present invention;

FIG. 3 shows a diagram of a flexographic printing process for making the laminate transfer film in an embodiment of the present invention; and

FIG. 4 shows a diagram of a substrate treated to show an image created by condensation according to the present invention.

### DETAILED DESCRIPTION OF THE INVENTION

A complete understanding of the invention will be obtained from the following description when taken in connection with the accompanying figures wherein like reference characters identify like parts throughout.

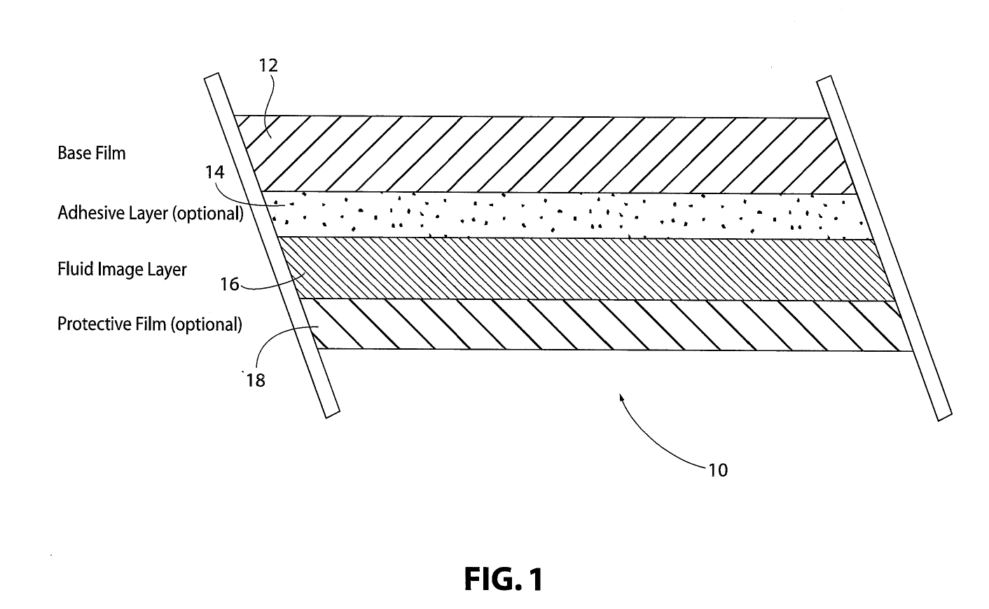

FIG. 1 shows a cross-sectional diagram of a laminate transfer film 10 of an embodiment of the present invention. The laminate transfer film 10 comprises a base film 12, an optional adhesive layer 14, a fluid image layer 16 and a protective film 18. Base film 12 and protective film 18 could be constructed from any appropriate film materials. The presence and composition of the adhesive layer 14 will primarily depend on the properties of the fluid image layer 16 and base film 12. Fluid image layer 16 comprises a surface modifying composition for modifying the hydrophobicity or hydrophilicity of a substrate (not shown).

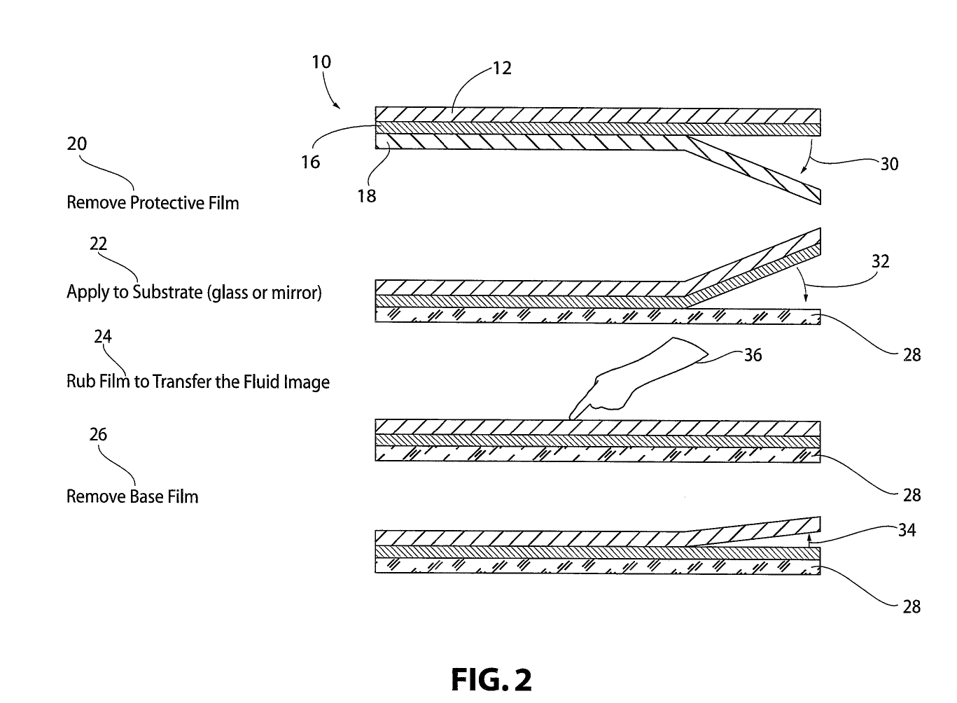

FIG. 2 shows a diagram of steps for using the laminate transfer film 10. In the first step 20, the protective film 18 is removed as indicated by directional arrow 30. In the second step 22, laminate transfer film 10 is applied fluid image layer 16 face down onto substrate 28, which is shown as glass, as indicated by directional arrow 32. In the third step 24, a user 36 rubs or presses base film 12 of a laminate transfer film 10 to apply fluid image layer 16 down to substrate 28. In the final step 26, the base film 12 is removed as indicated by directional arrow 34 leaving fluid image layer 16 adhered to substrate 28.

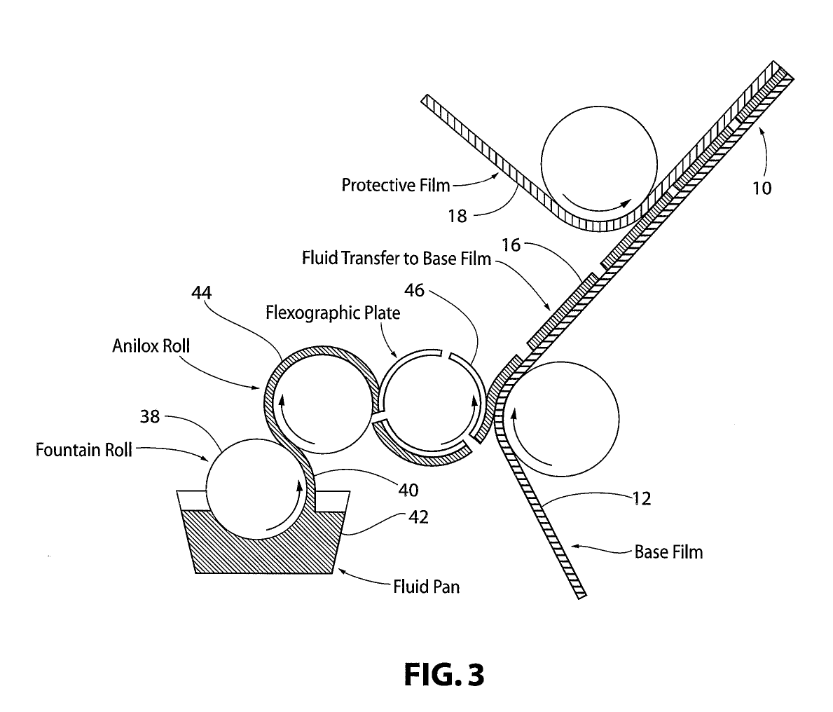

FIG. 3 shows a diagram of a flexographic printing process for making the laminate transfer film shown in FIG. 2. Fountain roll 38 supplies surface modifying composition 40 from fluid pan 42 to anilox roll 44. Anilox roll 44 then applies surface modifying composition 40 to flexographic plate 46. Flexographic plate 46 then applies surface modifying composition 40 to base film 12 in a predetermined pattern, shape, image or the like, creating fluid image layer 16. Protective film 18 is then applied to the fluid mage layer 16 on base film 12. Laminate transfer film 10 then may be cut as desired for the given application.

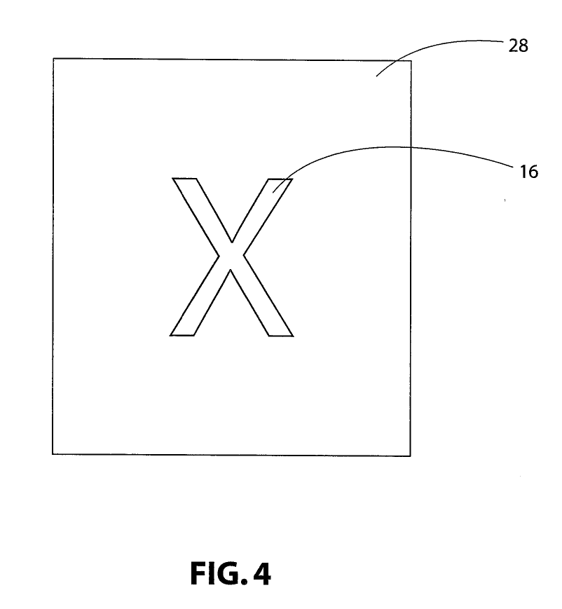

FIG. 4 shows a diagram of a substrate 28 treated to show an image created by condensation according to the present invention. Fluid image layer 16 is adhered to substrate 28 so that when substrate 28 is moved from a cooler less humid environment to a warmer more humid environment water condensates and beads on substrate 28 except for the portions covered by fluid mage layer 16. For example, the portion of substrate 28 covered by fluid image layer 16 is wetted, therefore light is not scattered as much compared to the untreated portions of substrate 28. This difference in surface hydrophobicity and/or hydrophilicity causes an image or pattern to form when condensation forms on the substrate.

It will be understood by those skilled in the art that while the foregoing description sets forth in detail preferred embodiments of the present invention, modifications, additions, and changes might be made thereto without departing from the spirit and scope of the invention.

The invention claimed is:

1. A device for imparting an image onto a surface via condensation comprising:
a first film sheet with a surface modifying composition disposed on said first film sheet,
wherein said surface modifying composition is substantially transparent.

2. The device of claim 1, further comprising a second film sheet in contact with said surface modifying composition protecting the surface modifying composition and holding said surface modifying composition in place.

3. The device of claim 1, further comprising an adhesive layer between said first film sheet and said surface modifying composition.

4. The device of claim 1, further comprising a second film sheet in contact with said surface modifying composition protecting the surface modifying composition and holding said surface modifying composition in place, and further comprising an adhesive layer between said first film sheet and said surface modifying composition.

5. The device of claim 1, wherein said surface modifying composition is disposed on said first film sheet so as to form at least one of a pattern, an image, and an indicia.

6. The device of claim 1, wherein said surface modifying composition comprises at least one of a silane, a siloxane, a silicone, a polymeric coating, a petroleum based oil, a petroleum based wax, a plant based oil, a plant based wax, an animal based oil, an animal based wax, a beeswax, a hydrogel, a water based coating, and a solvent based coating.

7. The device of claim 1, wherein said surface modifying composition comprises at least one of a silane, and a siloxane, capable of permanently modifying a surface.

8. The device of claim 1, wherein said surface modifying composition comprises at least one of a silicone, a polymeric coating, a petroleum based oil, a petroleum based wax, a plant based oil, a plant based wax, an animal based oil, an animal based wax, a beeswax, a hydrogel, a water based coating, and a solvent based coating, capable of temporarily modifying a surface.

9. A method of imparting an image onto a surface via condensation comprising the steps of:
providing a first film sheet with a surface modifying composition disposed on said first film sheet,
wherein said surface modifying composition is substantially transparent;
placing the first film sheet onto a substrate with said surface modifying composition being in contact with said substrate, and
removing the first film sheet from the substrate so that at least a portion of the surface modifying composition remains in contact with the substrate.

10. The method of claim 9, further comprising the step of applying pressure to the first film sheet on the substrate to apply the surface modifying composition to the substrate.

11. The method of claim 9, further comprising the step of positioning an adhesive layer between said first film sheet and said surface modifying composition.

12. The method of claim 9, further comprising the steps of positioning a second film sheet in contact with said surface modifying composition for protecting the surface modifying composition and holding said surface modifying composition in place, and removing said second film sheet from contact with said surface modifying composition.

13. The method of claim 9, further comprising the steps of positioning an adhesive layer between said first film sheet and said surface modifying composition,
positioning a second film sheet in contact with said surface modifying composition protecting the surface modifying composition and holding said surface modifying composition in place, and
removing said second film sheet from contact with said surface modifying composition.

14. The method of claim 9, wherein said surface modifying composition is disposed on said first film sheet so as to form at least one of a pattern, an image, and an indicia.

15. The method of claim 9, wherein said surface modifying composition comprises at least one of a silane, a siloxane, a silicone, a polymeric coating, a petroleum based oil, a petroleum based wax, a plant based oil, a plant based wax, an animal based oil, an animal based wax, a beeswax, a hydrogel, a water based coating, and a solvent based coating.

16. The method of claim 9, wherein said surface modifying composition comprises at least one of a silane, and a siloxane, permanently modifying a surface of the substrate.

17. The method of claim 9, wherein said surface modifying composition comprises at least one of a silicone, a polymeric coating, a petroleum based oil, a petroleum based wax, a plant based oil, a plant based wax, an animal based oil, an animal based wax, a beeswax, a hydrogel, a water based coating, and a solvent based coating, temporarily modifying a surface of the substrate.

18. The method of claim 9, wherein the substrate is constructed of at least one of a glass, a plastic, a ceramic, a metal, and a stone.

19. The method of claim 9, wherein the substrate is a glass.

20. The method of claim 9, wherein the substrate is a plastic.
